(19) United States
(12) Patent Application Publication
(10) Pub. No.: US 2007/0169633 A1
(43) Pub. Date: Jul. 26, 2007

(54) Method for making and selectively dispensing a beverage

(76) Inventors: Brian K. Beesley, Draper, UT (US); Claude Brandt, Salt Lake City, UT (US); Kelly Harvard, Layton, UT (US); Eric Hales, Ogden, UT (US)

Correspondence Address: THORPE NORTH & WESTERN, LLP., 8180 SOUTH 700 EAST, SUITE 200, SANDY, UT, 84070, US

(21) Appl. No.: 11/488,443

(22) Filed: Jul. 13, 2006

Related U.S. Application Data
(60) Provisional application No. 60/706,932, filed on Aug. 9, 2005.
(60) Provisional application No. 60/781,495, filed on Mar. 11, 2006.

(51) Int. Cl. A47J 31/00

(52) U.S. Cl. 99/279

(57) ABSTRACT

A method for making and selectively dispensing a beverage includes making the beverage in a base and storing the beverage in a carafe removably disposed in a carafe receptacle of the base. The carafe is selectively laterally removed from a lateral opening in the base; the carafe is tipped and the beverage poured from a top of the carafe; and the carafe is laterally replaced into the lateral recess of the base. The carafe is selectively retained on the base and the beverage dispensed from a downward facing outlet on a bottom of the carafe by selectively displacing a valve disposed in the outlet.

Priority is claimed of U.S. Provisional Patent Application Ser. Nos. 60/706,932, filed Aug. 9, 2005, and 60/781,495, filed Mar. 11, 2006, which are herein incorporated by reference.

This is related to U.S. patent application Ser. No.______, filed Jul. 13, 2006, as TNW docket No. 01198-21961, entitled “Coffee Maker with Dual Use Pour and Dispensing Carafe,” which is herein incorporated by reference.

### BACKGROUND OF THE INVENTION

1. Field of the Invention

The present invention relates generally to making and dispensing beverages, such as coffee and the like. More particularly, the present invention relates to a method of making and selectively dispensing a beverage by pouring the beverage from a carafe or dispensing through a valve in a bottom of the carafe.

2. Related Art

Coffee makers or brewing stations are commonly used for making or brewing coffee. Such coffee makers typically include a fresh water chamber, a heating element to heat water, a filter basket that receives coffee grounds and the hot water, and a coffee pot that received the coffee (or hot water that passes through the coffee grounds in the filter basket). A heat plate may be disposed under the coffee pot to keep the coffee hot. Various controls, timers, and/or programs can be used to operate the coffee maker.

More recently, a coffee maker has been developed, namely the BrewStation™by Hamilton Beach, in which a brewed beverage tank is formed as part of the brew station and includes a filter basket therein and an outlet port in the bottom to dispense coffee therethrough. See U.S. Patent Nos. 6,564,975 and 6,681,960; and U.S. Patent Publication Nos. 2004/0118299 A1 and 2004/0244598 A1. Thus, the carafe has been eliminated.

It will be appreciated that in traditional coffee makers the coffee pot must be removed from the coffee maker to pour coffee through an upper opening, while in the newer BrewStation™ coffee is only dispensed through a bottom of the brewed beverage tank.

### SUMMARY OF THE INVENTION

It has been recognized that it would be advantageous to develop a coffee maker, brew station, or hot beverage maker with a dual use carafe that is both removable to pour coffee through the top and capable of dispensing coffee through a bottom outlet while remaining on the coffee maker.

The present invention provides a method for making and selectively dispensing a beverage, including: making the beverage in a base and storing the beverage in a carafe removably disposed in a carafe receptacle of the base; selectively laterally removing the carafe from a lateral opening in the base, tipping the carafe and pouring the beverage from a top of the carafe, and laterally replacing the carafe into the lateral recess of the base; and selectively retaining the carafe on the base and dispensing the beverage from a downward facing outlet on a bottom of the carafe by selectively displacing a valve disposed in the outlet.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a beverage maker, brewstation or coffee maker apparatus in accordance with an embodiment of the present invention.

FIG. 2 is a perspective view of the coffee maker apparatus of FIG. 1 with a carafe removed.

FIG. 3 is a cross-sectional side view of the coffee maker apparatus of FIG. 1.

FIG. 4 is a front view of the coffee maker apparatus of FIG. 1.

FIG. 5 is a left side view of the coffee maker apparatus of FIG. 1.

FIG. 6 is a cross-sectional side view of a carafe of the coffee maker of FIG. 1 in accordance with an embodiment of the present invention.

FIG. 7 is a bottom view of the carafe of FIG. 6.

FIG. 8 is a partial perspective view of the coffee maker apparatus of FIG. 1 with the carafe removed.

FIG. 9 is a partial perspective bottom view of the carafe of FIG. 6, with a bottom plate removed from a valve for clarity.

FIG. 10 is a partial perspective bottom view of a valve and locking mechanism of the carafe of FIG. 6 in accordance with an embodiment of the present invention.

FIG. 11 is a partial front view of the valve and locking mechanism of FIG. 10.

FIG. 12 is a partial cross-sectional side view of the valve and locking mechanism of FIG. 10.

FIG. 13 is a top view of the coffee maker apparatus of FIG. 1.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

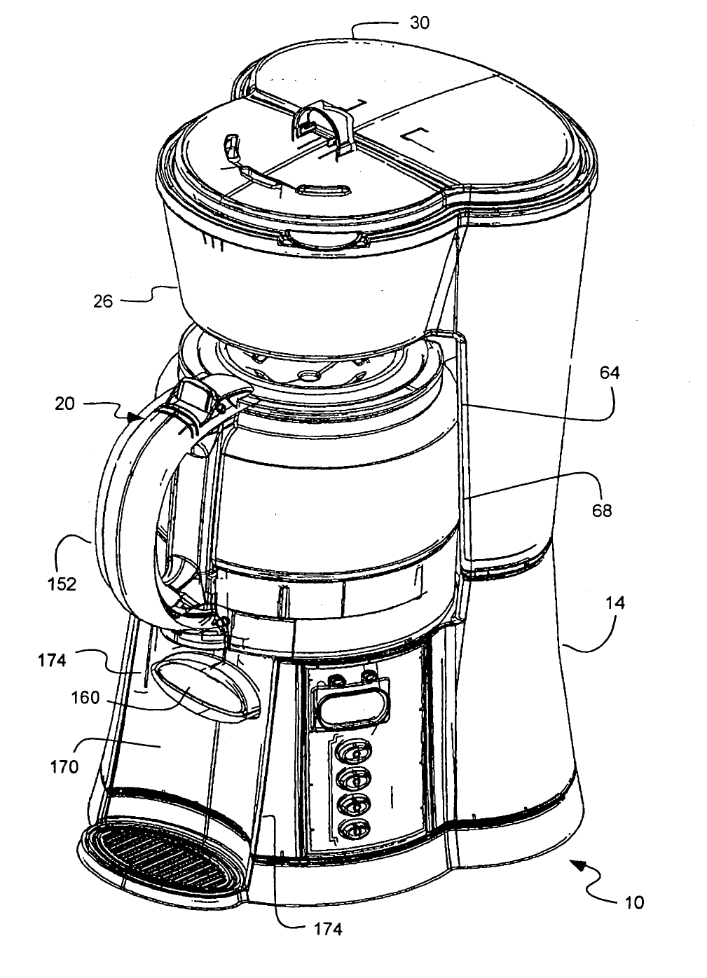

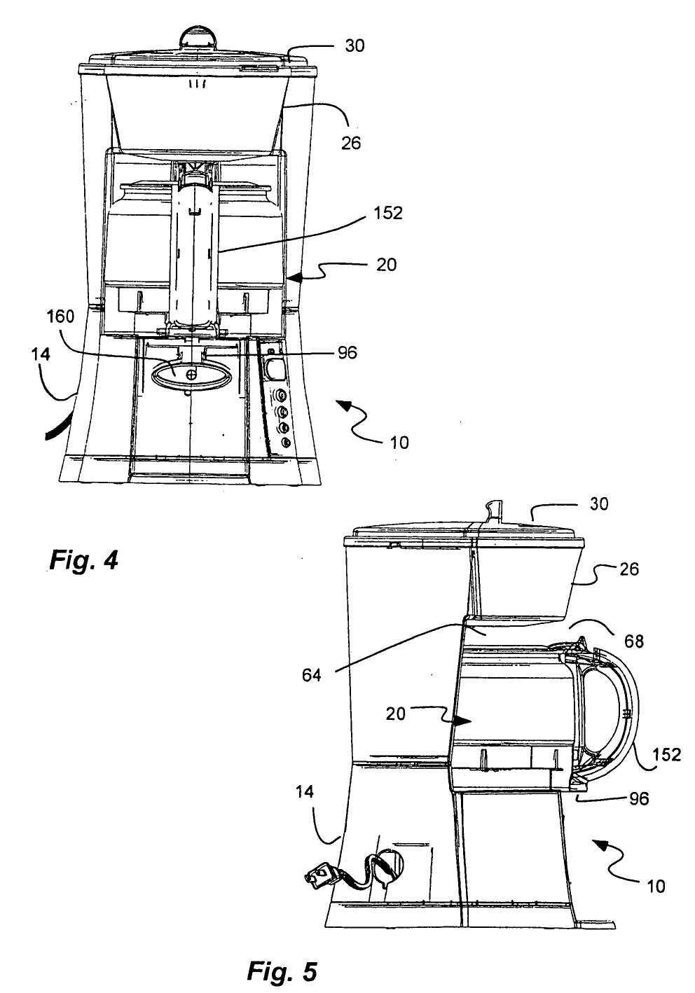

As illustrated in FIGS. 1-5, a beverage maker, brewstation or coffee maker 10 with a carafe 20 in accordance with the present invention is shown for making beverages, such as coffee. While the beverage maker or coffee maker 10 will be described herein with reference to a coffee maker for making coffee, it will be appreciated that the present invention can be utilized to make any type of drink, including tea, ice tea, cocoa, etc.

The carafe 20 can dispense beverages contained therein through openings in either the top of the carafe or the bottom of the carafe. Beverage can be dispensed from the top of the carafe by removing the carafe from the coffee maker and tipping the carafe until beverage comes out an opening in the top of the carafe. Beverage can also be dispensed from the bottom of the carafe by actuating a valve in the bottom of the carafe to open an outlet in the bottom of the carafe, thereby dispensing the beverage. Thus, the coffee maker or carafe has a dual function or dual dispensing capability. Namely, beverage can be dispensed from an outlet below the carafe while the carafe is mounted on the coffee maker, and the carafe can be easily removed and used as a regular coffee pot by pouring coffee out of the top.

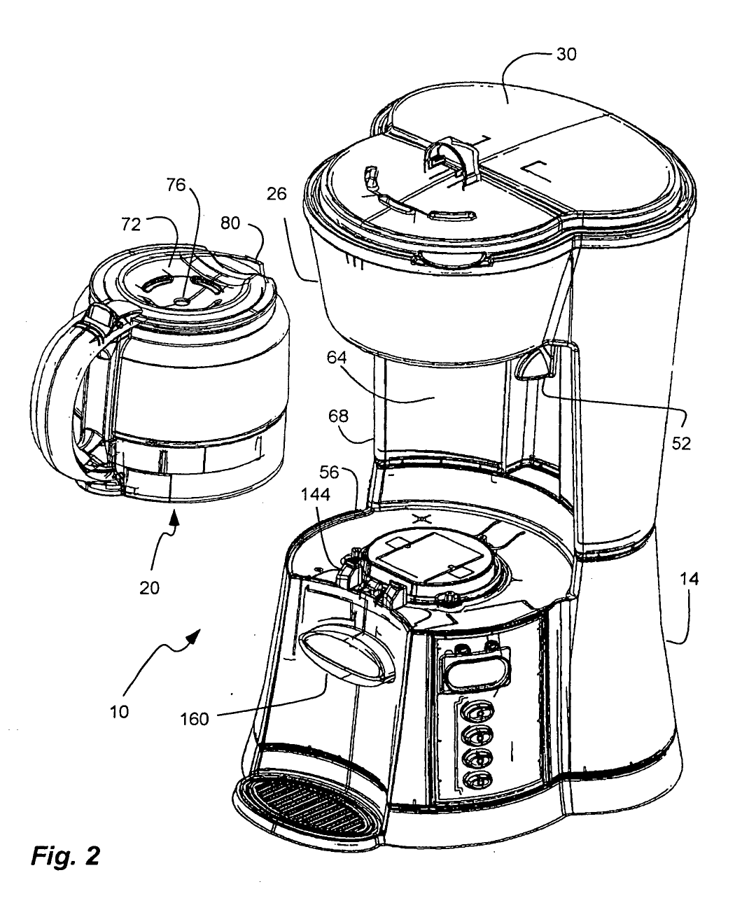

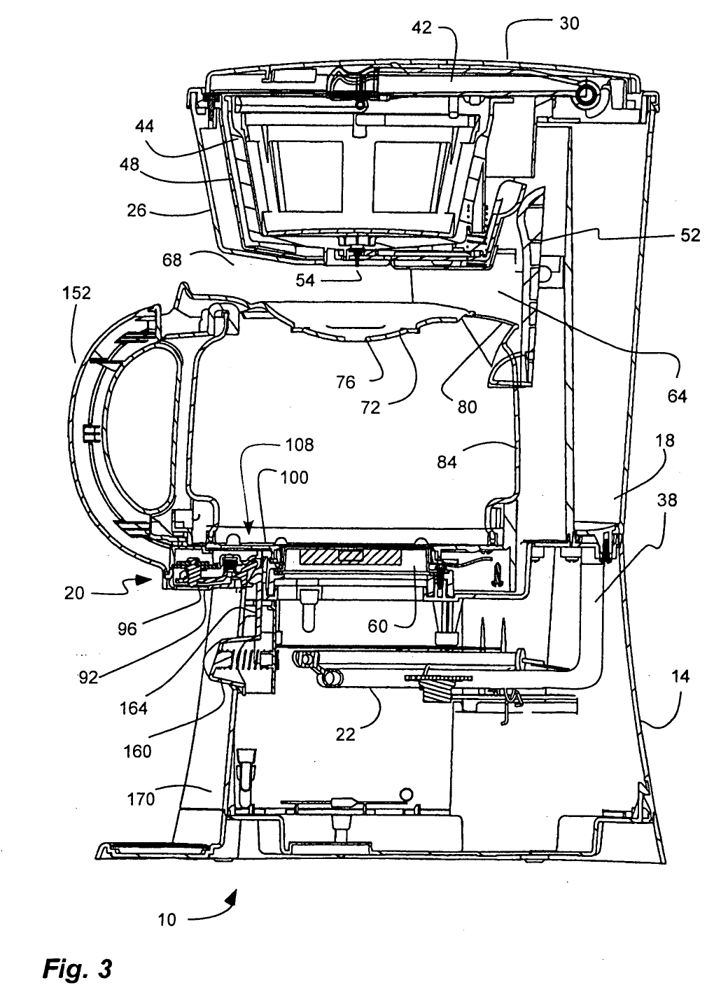

The coffee maker 10 includes a base 14 or housing configured to be disposed on a working surface, such as a counter. The base 14 can include mechanisms to make a beverage or coffee, such as: a fresh water reservoir 18 (FIG. 3) configured to receive water; a heating element 22 (FIG. 3) configured to heat the water; and a filter compartment 26 configured to receive coffee grounds and heated water from the heating element. As shown in FIG. 2, a lid 30 of the base 14 can be pivoted open to reveal or provide access to the filter compartment 26 and the reservoir 18. The filter compartment 26 can be disposed at a top of the base 14, while the reservoir 18 can be disposed lower than the filter compartment. The heating element 22 can also be disposed in the bottom of the base 14, and in, or operatively coupled to, the reservoir 18. A tube 38 can extend from the water reservoir 18, through the heating element 22, and up to the filter compartment. Thus, in operation, the lid 30 can be pivoted open, and water poured through an opening in the top into the reservoir 18. The water can be heated by the heating element 22, causing the heated water to rise in the tube to the top of the base. A pivot tube 42 (FIG. 3) can be pivotally coupled to the tube 38 and carried by the lid 30 to pivot open with the lid and pivot over the filter compartment when closed. (The portion of the tube 38 extending from the heating element up to the pivot tube 42 cannot be seen in FIG. 3)

Coffee grounds can be placed in a filter, which can be placed in a filter support 44 (FIG. 3), which can be placed in a filter cup 48 (FIG. 3), which can be placed in the filter compartment 26. The filter cup 48 can form a cup-like enclosure that is substantially closed at a bottom and sides, but open at the top to receive the coffee grounds, filter, and/or filter support 44. Likewise, the filter compartment can be substantially closed at a bottom and sides, but open at the top. Heated water from the heating element can react with the coffee grounds to form brewed or liquid coffee. The above-described mechanisms are intended to be a general description and can vary in location and operation, as known in the art. In addition, some of the mechanisms are optional, such as the filter support 44 and filter cup 48. The filter cup 48 (and associated valve described below) can be removable to facilitate cleaning.

The filter compartment 26 can be fixed with respect to the base 14. For example, the filter compartment 26 can be integrally formed with the base, or a wall forming the base can also form the filter compartment. In addition, the filter compartment 26 is disposed over the carafe 20 when the carafe is on the base. An opening can be formed in the filter compartment 26 (and filter cup 48) to allow brewed coffee to pass through the opening and into the carafe. A linkage, indicated generally at 52 (FIG. 3), can be engaged or operated by the position of the carafe 20 on the base to open a valve 54 (FIG. 3) associated with filter compartment 26, such as disposed in the opening of the filter cup 48, as shown.

The base 14 can also include a carafe platform 56 (FIG. 2) to receive the carafe 20. Thus, the carafe can be supported by the carafe platform. The platform 56 can include a heating element 60 (FIG. 3), or can utilize heat from the heating element 22 for the reservoir, to keep warm the contents or coffee in the carafe. The carafe platform and heating element 60 can form or include a heating plate to keep the contents of the carafe warm. The carafe platform 56 can include a protrusion, with the heating element, to extend into an indentation of the carafe. The protrusion and indentation can be shaped to orient the carafe on the base or carafe platform. The protrusion and indentation are one example of alignment means for aligning the carafe on the base or carafe platform.

A carafe receptacle 64 can be formed in the base 14 and can receive the carafe 20 in the base when the carafe is disposed on the carafe platform 56. The carafe receptacle 64 is defined above by the filter compartment 26, and below by the carafe platform 56. The filter compartment 26 can also be fixed with respect to the carafe platform 56. A carafe opening 68 is formed in a side of the base 14 and extends to the carafe receptacle 64. The carafe opening 68 is a lateral or side opening formed on a lateral side of the base. Thus, the carafe 20 is laterally removed and placed on the base 14 through the lateral opening 68.

The carafe 20 is separate and distinct from the base 14, and the filter compartment 26. In addition, the carafe 20 is removable from the base 14 and disposable in the carafe receptacle 64 of the base through the carafe opening 68. The carafe 20 is also disposable on the carafe platform 56 with the filter compartment 26 disposed over the carafe. The carafe 20 can have an openable upper end to receive and dispense coffee. For example, the carafe can be open, or have an open upper end, selectively covered by a carafe lid 72 that can be pivotally or movably coupled to the carafe. By way of example, the carafe lid 72 can have an opening 76 aligned with the opening and/or valve 54 (FIG. 3) of the filter compartment 26 or filter cup 48 so that brewed coffee from the filter compartment can pass into the carafe, through the opening 76 in the carafe lid 72. A spout 80 or chute can be formed in the carafe and can define another opening in the carafe lid through which coffee can be dispensed or poured. Thus, when the carafe 20 is removed from the base 14, coffee can be selectively dispensed from the open upper end, such as by tipping the carafe. When the carafe 20 is disposed on the base 14, the carafe can receive brewed coffee from the filter compartment. The lid can be formed of plastic.

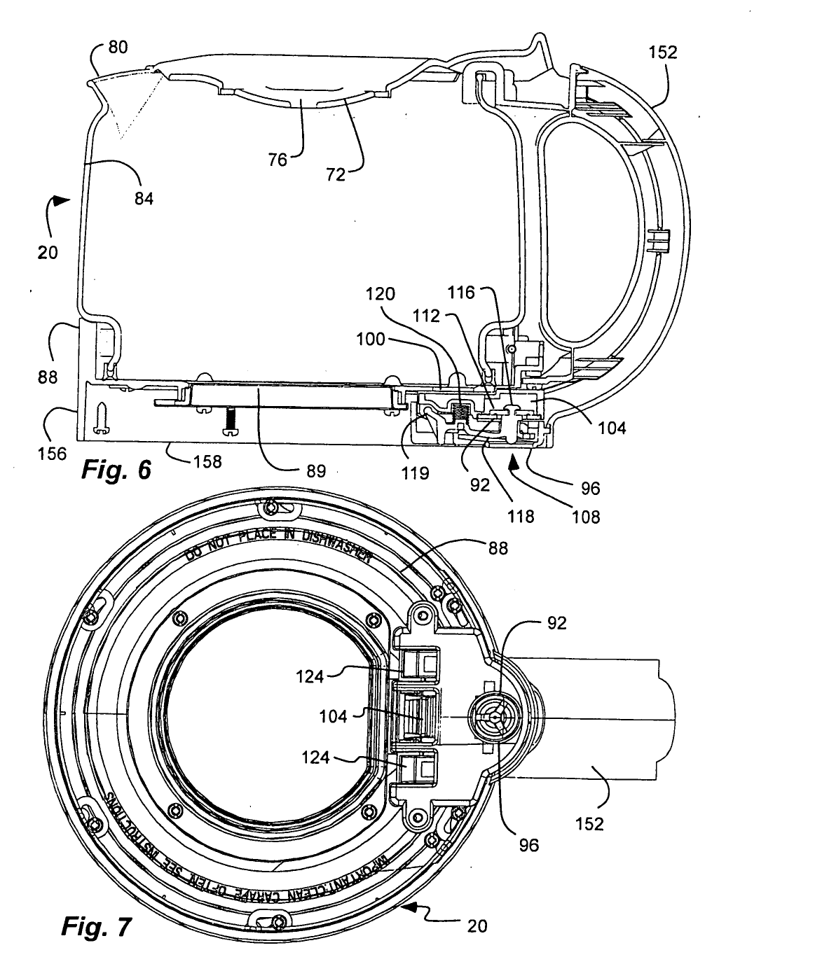

The carafe 20 can have an upper annular shell 84 and a lower carafe base 88 (FIG. 6) forming a vessel or container. The annular shell 84 can be transparent or translucent, and can be formed of glass. In addition, the spout 80 can be formed in the top of the annular shell, and the top of the carafe 20 or annular shell 84 can be selectively closed by the carafe lid 72. The bottom of the carafe 20 or annular shell 84 can be closed by the carafe base 88. The carafe base 88 can be formed of or include plastic. An annular groove or channel can be formed in a bottom of the annular shell 84. The carafe base 88 can surround the annular channel to attach the carafe base 88 to the annular shell. The carafe base 88 can include the indentation, as described above, in an indented bottom plate 89 to receive the protrusion and heating element. The bottom plate 89 can be metal to facilitate heat transfer to coffee in the carafe. The carafe 20 or carafe base 88 can have a substantially horizontal bottom. The carafe 20 can have an interior bottom wall formed by the carafe base 88. The interior bottom wall can be substantially horizontal, although it can have a slight inclination. In addition, the carafe 20 or carafe base 88 can have an exterior bottom that is horizontal so that the carafe can be disposed on a surface, such as a counter.

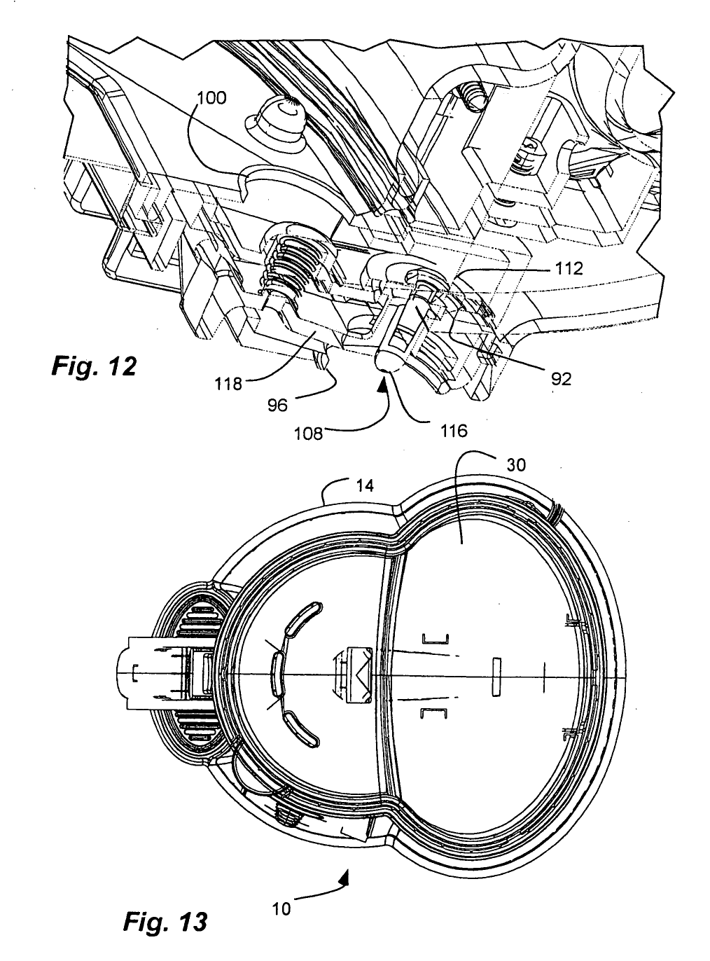

Referring to FIGS. 6, 7 and 12, an outlet 92 can be disposed in the bottom of the carafe 20, or in the carafe base 88, so that coffee can be dispensed through the outlet. The outlet 92 can include a downward facing outlet opening 96 (FIG. 7) disposed in the horizontal bottom wall of the carafe, or of the carafe base 88. Similarly, the outlet 92 can include an upward facing inner opening 100 (FIG. 6) formed in an interior of the carafe. The outlet opening 96 can be disposed radially outward to facilitate dispensing through the outlet 92 while the carafe is on the base. Thus, the outlet opening 96 can be disposed at least partially outside a circular perimeter of the carafe, such as defined by the annular shell 84, as shown in FIG. 7. The inner opening 100 can be disposed further inwardly to communicate with the coffee. Thus, the inner opening 100 and the outlet opening 96 can be radially offset with respect to one another. The inner and outer openings can be intercoupled or interconnected by a chute 104 (FIG. 6) or channel.

A valve 108 (FIG. 6) can be disposed in the outlet 92 and operable to selectively open and close the outlet 92, and to selectively dispense brewed coffee from the bottom of the carafe when the carafe is disposed on the base. In one aspect, the valve 108 can include a seal 112 (FIG. 6) carried by valve stem 116 (FIG. 6) and extending across the outlet 92. The stem can be displaced upwardly to move the seal and open the outlet. In one aspect, a lever arm 118 can engage the stem 116 and selectively pivot to displace the seal and the stem. The lever arm 118 can have a pivot 119 disposed at an inner end of the lever arm to pivotally couple the lever arm to the carafe. The valve can be biased in the closed position by a bias member 120 (FIG. 6), such as a spring, disposed at an inner end of the lever arm. The stem can be disposed at an outer end of the lever arm. The lever arm 118 can be disposed under the inner opening 100 and can engage the valve 108 or stem 116. An actuator linkage (described below) can engage the lever arm 118 to displace the valve. The lever arm 118 can be integrally formed with the stem 116.

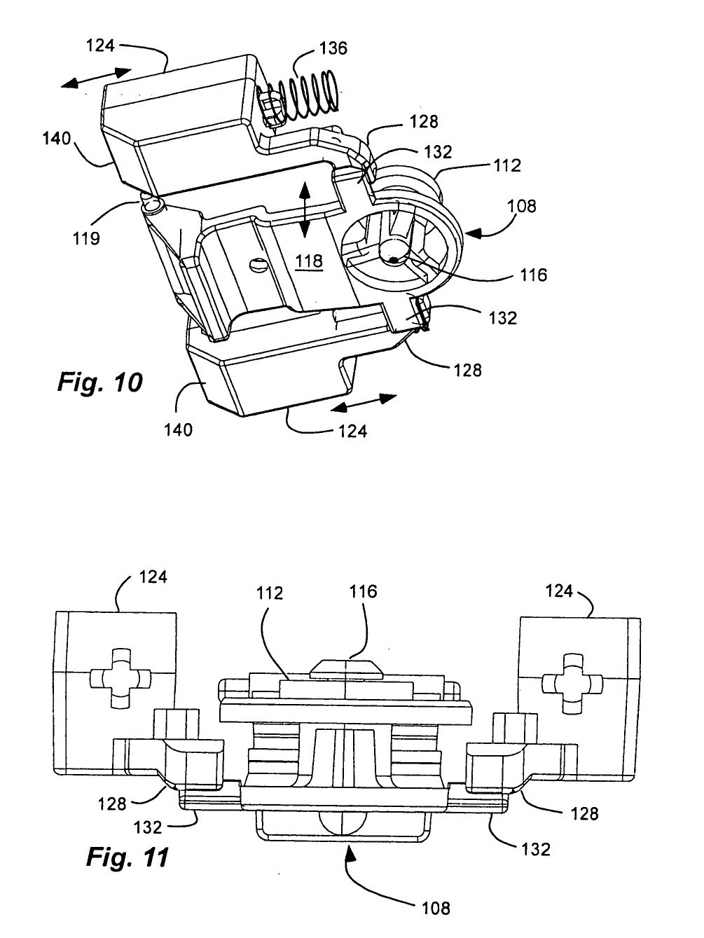

Referring to FIGS. 6 and 8-11, the carafe 20 can include an automatic lock that locks the valve 108 (FIG. 6) when the carafe is removed from the base to resist inadvertent dispensing through the outlet 92, and that unlocks when the carafe is disposed on the base 14. Referring to FIGS. 2, 8 and 9, the lock can include a locking member 124 (or pair of locking members on either side of the valve) carried by the carafe 20 and engagable with the valve 108 to prevent movement of the valve when the carafe is removed from the base. (In FIG. 9, a bottom plate has been removed from below the valve for clarity.) The locking member 124 can move back and forth between a lock position and an unlock position. The locking member 124 can have a tab 128 that engages another tab 132 on the chute 104 (as shown in FIG. 9 with the chute removed for clarity) when in the lock position. The tab 128 of the locking member 124 can be disposed over a tab 132 of the lever arm 118 to resist movement of the lever arm, and thus movement of the valve, upwardly, or to open. The tab 128 of the locking member 124 can displace with the locking member to allow the lever arm 118, and thus the valve 108, to move upwardly and open. The locking member 124 can be biased to the lock position by a bias member 136, such as a spring. A pair of locking members 124 can be disposed with one on each side of the lever arm, as shown in FIG. 9. The locking member 124 can also include an inclined surface 140 facing downward.

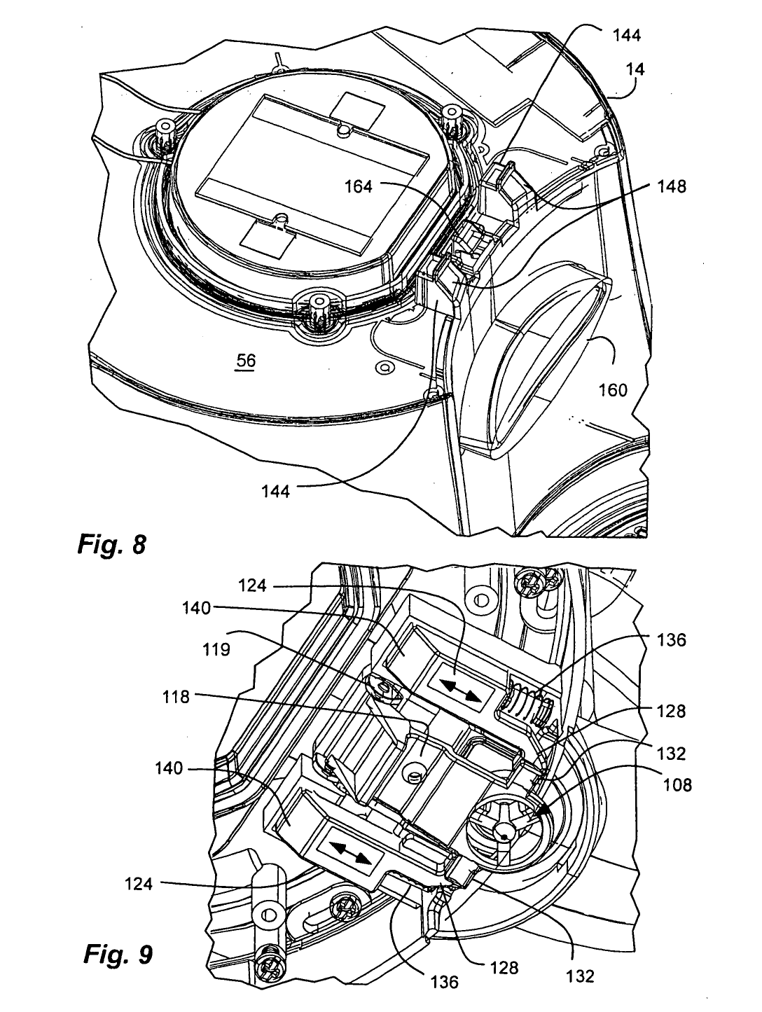

The lock can also include an unlock protrusion 144 (FIG. 8) or key disposed on and extending from the base 14 or carafe platform 56. The unlock protrusion can include an inclined surface 148 facing upwardly to engage the inclined surface 140 of the locking member 124 to displace the locking member when the carafe is disposed on the base. As the carafe 20 is disposed on the base 14 or carafe platform 56, the unlock protrusion 144 engages and displaces the locking member 124 to the unlock position. As the carafe 20 is removed from the base or carafe platform, the unlock protrusion disengages from the locking member and the bias member can displace the locking member to the lock position.

The valve 108, the lever arm 118, and the locking members 124 can be disposed in the carafe 20, or in the carafe base 88. In one aspect, the horizontal bottom of the carafe or carafe base can extend below the valve 108, the lever arm 118 and the locking member 124 (or the valve 108, the lever arm 118 and the locking members 124 can be disposed above a horizontal bottom of the carafe base) so that the carafe can be disposed on a flat horizontal surface without inadvertently actuating the valve. The carafe 20 or carafe base 88 can have a lower skirt 156 (FIG. 6) having a flat, horizontal bottom 158 (FIG. 6) extending below the valve and defining a downward facing pocket in which the valve is disposed such that the bottom of the carafe can be disposed on flat support surface without the valve engaging the support surface.

The carafe 20 can have a handle 152 disposed along a side of the carafe. The handle 152 can be vertically oriented, and can extend along a height of the carafe, from the top of the carafe to the bottom. The carafe lid 72 can be coupled to a top of the handle 152. The lid can have a thumb tab that the user can press to open the lid while grasping the handle. The thumb tab can extend into a depression in the handle when the tab is depressed. The top of the handle 152 can have a hook to engage the top of the annular shell 84. The bottom of the handle can be coupled to the carafe base 88. The handle 152 can extend from the carafe receptacle 64 of the base 14 through the carafe opening 68 when the carafe is disposed on the base to allow a user to grasp and remove the carafe from the base, as shown in FIG. 5. The handle can be formed of plastic.

Referring to FIG. 6, in one aspect, the outlet opening 100 or outlet 92 and the handle 152 are radially aligned. Aligning the handle with the outlet opening provides a visual indicator of the location of the outlet opening (as it will be appreciated that the outlet is not readily visible). In addition, the outlet 92 or outlet opening 96 can be at least partially formed in a bottom portion of the handle 154 of the carafe. Positioning the outlet 92 or outlet opening 96 into the handle allows the outlet opening to be disposed further radially outwardly to facilitate dispensing when the carafe is on the base.

Referring again to FIGS. 1-4 and 8, a valve actuator 160 can be disposed on the base 14 to be engaged by a user to operate the valve 108 of the carafe. In one aspect, the valve actuator 160 can be disposed below the valve 108 and below the receptacle 64 so that the user can actuate the valve actuator with a cup or mug. For example, the cup or mug can be placed under the carafe, and under the valve, and pressed against the valve actuator to dispense coffee from the carafe into the cup or mug. As described above, a linkage 164 (FIG. 3) can extend from the valve actuator 160 on the base 14 to the valve 108 in the outlet of the carafe 20. At least of portion of the linkage 164 and valve actuator 160 can be integrally formed, with an extension of the valve actuator pivoting or displacing to engage and displace the lever arm 118, which in turn displaces the valve 108. It will be appreciated that the linkage 164 can take many forms. In one aspect, the linkage can be formed by the valve actuator and lever arm. The valve actuator can be biased, such as with a spring.

A cup indentation 170 can be formed in the base 14 under the carafe 20, the outlet opening 96 and the valve 108. The cup indentation 170 can be defined between lateral protrusions 174 (FIG. 1) of the base extending on either side of the cup indentation. As described above, the carafe 20 and base 14 (or the carafe platform 56 or the receptacle 64) can be configured to orient the carafe with respect to the base and the cup indentation. For example, the carafe and base can have matching or mating indentation and protrusion. Such indentation and protrusion are examples of alignment means for aligning the outlet opening with the cup indentation. It will be appreciated that other configurations or structures can be used, including the unlock protrusion, etc. In addition, the handle 152 aligned with the outlet opening can also be used to correctly orient the carafe on the base. The valve actuator 160 can be disposed in the cup indentation 170 and contactable by a cup inserted into the cup indentation.

The coffee maker 10 described above can be described as having three distinct elevational levels including: a lowermost dispensing level to receive a cup, defined below the carafe; an intermediate storage level to receive the carafe and defined by the carafe when disposed in the carafe receptacle of the base; and an uppermost brewing level defined by the filter compartment.

In use, the coffee maker 10 can be used to make coffee as understood in the art. For example, coffee grounds can be placed in a coffee filter in the filter support 44 in the filter cup 48 in the filter compartment 26. Water can be placed in reservoir 18. The water and coffee grounds can be added by pivoting the lid 30 open. Controls on the base can be engaged, causing the heating element 22 to heat the water and rise through the tubes 38 and 42 into the coffee grounds in the filter compartment. The brewed coffee can pass through the filter compartment and into the carafe 20. As described above, coffee can be dispensed in two ways. First, a cup can be disposed under the carafe 20 and outlet opening 96 to receive coffee from the outlet 92 of the carafe. The cup can engage the actuator 160 which opens the valve 108. Second, the carafe 20 can be removed from the base 14 and tipped to pour coffee through the open upper end 80.

A method for using the coffee maker 10 described above, and for making coffee and selectively dispensing the coffee, includes: inserting a carafe 20 through a lateral opening 68 in a base 14 and into a carafe receptacle 64 in the base; filling a water reservoir 18 in the base with water; placing coffee grounds in a filter compartment 26 in the base and over the carafe receptacle; causing the water to heat with a heater 22 in the base and enter the filter compartment with the coffee grounds to form a brewed coffee; allowing the brewed coffee to pass from the filter compartment into the carafe; selectively pouring the brewed coffee from an open upper end of the carafe by laterally removing the carafe from the carafe receptacle through the lateral opening and tipping the carafe; or laterally replacing the carafe into the carafe receptacle through the lateral opening; and selectively dispensing the brewed coffee from the base by retaining the carafe on the base and selectively activating a valve actuator 160 on the base to engage a valve 108 disposed in an outlet 92 disposed in a substantially horizontal bottom wall of the carafe to allow brewed coffee to flow from the carafe, through the outlet.

Filling a water reservoir and placing coffee grounds in a filter compartment can further include opening a lid 30 on the base that extends over the filter compartment and a water inlet while the filter compartment remains fixedly disposed over the carafe receptacle.

Inserting a carafe can further include disposing the carafe on a carafe platform 56 at the bottom of the carafe receptacle and onto a heating element 60 associated with the carafe platform. In addition, inserting a carafe can further include automatically disengaging a safety lock on the carafe that engages the valve when the carafe is removed from the base to resist inadvertent dispensing of the brewed coffee through the outlet. Selectively pouring the brewed coffee can further include automatically engaging the safety lock on the carafe when the carafe is removed from the base. Furthermore, inserting a carafe can further include disposing the carafe against a protrusion 144 extending from the base that engages and displaces a locking member 124 disposed on the carafe and engagable with the valve when the carafe is removed from the base but displaceable from the valve by the protrusion when the carafe is disposed on the base. Furthermore, inserting a carafe can further include aligning the outlet of the carafe with a cup indentation 170 of the base by aligning the handle 152 of the carafe with the cup indentation, the outlet being radially aligned with the handle.

Selectively dispensing can further include: inserting a cup into a cup indentation 170 formed in the base between lateral protrusions 174 of the base extending from the base on either side of the valve actuator, the outlet of the carafe overhanging a perimeter of the carafe receptacle, over the cup indentation and between the lateral protrusions; and pressing a cup against the valve actuator disposed on the base, the cup actuator being connected to the valve by a linkage 164 extending from the valve actuator on the base to the valve in the outlet of the carafe.

A method for using the coffee maker 10 described above, and for making and selectively dispensing a beverage includes: making the beverage in a base 14 and storing the beverage in a carafe 20 removably disposed in a carafe receptacle 64 of the base; selectively laterally removing the carafe from a lateral opening 68 in the base, tipping the carafe and pouring the beverage from a top of the carafe, and laterally replacing the carafe into the lateral recess of the base; and electively retaining the carafe on the base and dispensing the beverage from a downward facing outlet on a bottom of the carafe by selectively displacing a valve 108 disposed in the outlet.

In addition, the method can include disposing the carafe against a protrusion extending from the base that engages and displaces a locking member disposed on the carafe and engagable with the valve when the carafe is removed from the base but displaceable from the valve by the protrusion when the carafe is disposed on the base.

Selectively retaining the carafe on the base and dispensing the beverage can further include inserting a cup into a cup indentation formed in the base between lateral protrusions of the base extending from the base on either side of the outlet.

The method can further include aligning the outlet of the carafe with a cup indentation of the base by aligning a handle disposed on a side of the carafe with the cup indentation, the outlet being radially aligned with the handle.

A method for instructing to make and selectively dispense a beverage includes providing a beverage maker apparatus with: a base including a carafe receptacle formed in the base and defined below by a carafe platform and above by an upper portion of the base; an opening formed in a side of the base and extending to the carafe receptacle; a carafe separate and distinct from the base, removable from and disposable in the receptacle of the base through the opening and on the carafe platform, the carafe having an openable upper end to selectively dispense contents of the carafe from the open upper end when the carafe is removed from the base and tipped; a handle disposed along a side of the carafe and extending from the receptacle through the opening when the carafe is disposed on the base to allow a user to grasp and remove the carafe from the base; an outlet disposed in a substantially horizontal bottom wall of the carafe; a valve disposed in the outlet operable to selectively dispense contents of the carafe from the bottom of the carafe when the carafe is disposed on the base; and the outlet having a downward facing outlet opening in the bottom of the carafe. The method can further include instructing to make a beverage in the beverage making apparatus; and instructing to selectively dispense the beverage by: 1) selectively laterally removing the carafe from the opening in the base, tipping the carafe and pouring the beverage from a top of the carafe, and laterally replacing the carafe into the recess of the base; or 2) selectively retaining the carafe on the base and dispensing the beverage from the outlet on a bottom of the carafe by selectively displacing the valve disposed in the outlet.

Although the carafe and coffee maker of the present invention have been described above with respect to making coffee, it will be appreciated that such a carafe can be used with other beverages, including for example, hot chocolate, cocoa, tea, Postum®, Milo®, herbal tea, ice tea, etc. Additionally, it will be appreciated that the term carafe as used herein includes any suitable type of beverage dispensing container such as a pitcher, flask, decanter, bottle or jug.

Various aspects of a cup indentation are shown in U.S. Pat. No. 6,527,433 and U.S. patent application Ser. No. 10/278,713(Pub. No. US 2003-0099154 A1), Ser. No. 10/959,491 (Pub. No. US 2005-0045671 A1), Ser. No. 11/045,014 and Ser. No. 11/069,737, which are herein incorporated by reference in their entirety.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method for making and selectively dispensing a beverage, comprising:
making the beverage in a base and storing the beverage in a carafe removably disposed in a carafe receptacle of the base;
selectively laterally removing the carafe from a lateral opening in the base, tipping the carafe and pouring the beverage from a top of the carafe, and laterally replacing the carafe into the lateral recess of the base; and
selectively retaining the carafe on the base and dispensing the beverage from a downward facing outlet on a bottom of the carafe by selectively displacing a valve disposed in the outlet.

2. A method in accordance with claim 1, further comprising:
disposing the carafe against a protrusion extending from the base that engages and displaces a locking member disposed on the carafe and engagable with the valve when the carafe is removed from the base but displaceable from the valve by the protrusion when the carafe is disposed on the base.

3. A method in accordance with claim 1, wherein selectively retaining the carafe on the base and dispensing the beverage further includes:
inserting a cup into a cup indentation formed in the base between lateral protrusions of the base extending from the base on either side of the outlet; and
engaging a valve actuator on the base in cup indentation with the cup to cause the valve to open.

4. A method in accordance with claim 1, further comprising:
aligning the outlet of the carafe with a cup indentation of the base by aligning a handle disposed on a side of the carafe with the cup indentation, the outlet being radially aligned with the handle.

5. A method for making coffee and selectively dispensing the coffee, comprising:
a) inserting a carafe through a lateral opening in a base and into a carafe receptacle in the base;
b) filling a water reservoir in the base with water;
c) placing coffee grounds in a filter compartment in the base and over the carafe receptacle;
d) causing the water to heat with a heater in the base and enter the filter compartment with the coffee grounds to form a brewed coffee;
e) allowing the brewed coffee to pass from the filter compartment into the carafe;
f) selectively pouring the brewed coffee from an open upper end of the carafe by laterally removing the carafe from the carafe receptacle through the lateral opening and tipping the carafe; and laterally replacing the carafe into the carafe receptacle through the lateral opening; and
g) selectively dispensing the brewed coffee from the base by retaining the carafe on the base and selectively activating a valve actuator on the base to engage a valve disposed in an outlet disposed in a substantially horizontal bottom wall of the carafe to allow brewed coffee to flow from the carafe, through the outlet.

6. A method in accordance with claim 5, wherein the steps of filling a water reservoir and placing coffee grounds in a filter compartment further include:
opening a lid on the base that extends over the filter compartment and a water inlet while the filter compartment remains fixedly disposed over the carafe receptacle.

7. A method in accordance with claim 5, wherein the step of inserting a carafe further includes:
disposing the carafe on a carafe platform at a bottom of the carafe receptacle and onto a heating element associated with the carafe platform.

8. A method in accordance with claim 5, wherein inserting a carafe further includes:
automatically disengaging a safety lock on the carafe that engages the valve when the carafe is removed from the base to resist inadvertent dispensing of the brewed coffee through the outlet; and
where selectively pouring the brewed coffee further includes:
automatically engaging the safety lock on the carafe when the carafe is removed from the base.

9. A method in accordance with claim 5, wherein the step of inserting a carafe further includes:
disposing the carafe against a protrusion extending from the base that engages and displaces a locking member disposed on the carafe and engagable with the valve when the carafe is removed from the base but displaceable from the valve by the protrusion when the carafe is disposed on the base.

10. A method in accordance with claim 5, wherein selectively dispensing further includes:
inserting a cup into a cup indentation formed in the base between lateral protrusions of the base extending from the base on either side of the valve actuator, the outlet of the carafe overhanging a perimeter of the carafe receptacle, over the cup indentation and between the lateral protrusions; and
pressing a cup against the valve actuator disposed on the base, the cup actuator being connected to the valve by a linkage extending from the valve actuator on the base to the valve in the outlet of the carafe.

11. A method in accordance with claim 5, wherein inserting a carafe further includes:
aligning the outlet of the carafe with a cup indentation of the base by aligning the handle of the carafe with the cup indentation, the outlet being radially aligned with the handle.

12. A method for instructing to make and selectively dispense a beverage, comprising:
a) providing a beverage maker apparatus, comprising:
i) a base including a carafe receptacle formed in the base and defined below by a carafe platform and above by an upper portion of the base;
ii) a opening formed in a side of the base and extending to the carafe receptacle;
iii) a carafe separate and distinct from the base, removable from and disposable in the receptacle of the base through the opening and on the carafe platform, the carafe having an openable upper end to selectively dispense contents of the carafe from the open upper end when the carafe is removed from the base and tipped;
iv) a handle disposed along a side of the carafe and extending from the receptacle through the opening when the carafe is disposed on the base to allow a user to grasp and remove the carafe from the base;
v) an outlet disposed in a substantially horizontal bottom wall of the carafe;
vi) a valve disposed in the outlet operable to selectively dispense contents of the carafe from the bottom of the carafe when the carafe is disposed on the base; and
vii) the outlet having a downward facing outlet opening in the bottom of the carafe;
b) instructing to make a beverage in the beverage making apparatus; and
c) instructing to selectively dispense the beverage by:
i) selectively laterally removing the carafe from the opening in the base, tipping the carafe and pouring the beverage from a top of the carafe, and laterally replacing the carafe into the recess of the base; or
ii) selectively retaining the carafe on the base and dispensing the beverage from the outlet on a bottom of the carafe by selectively displacing the valve disposed in the outlet.
